(19) United States
(12) Patent Application Publication
(10) Pub. No.: US 2003/0151246 A1
(43) Pub. Date: Aug. 14, 2003

(54) Photoengraved printed data carrier

(76) Inventors: Christof Baldus, (US); Franz Daniel, Ismaning (DE); Adolf Preidt, Olching (DE); Theodor Rebele, M?uuml;nchen (DE)

Correspondence Address: BACON & THOMAS, PLLC, 625 SLATERS LANE, FOURTH FLOOR, ALEXANDRIA, VA, 22314

(21) Appl. No.: 10/239,179

(22) PCT Filed: Mar. 26, 2001
(86) PCT No.: PCT/EP01/03418

(30) Foreign Application Priority Data
Mar. 28, 2000 (DE) 100 15 097.7

(51) Int. Cl. B42D 15/00

(52) U.S. Cl. 283/57

(57) ABSTRACT

The invention relates to a printed data carrier having a printed surface and at least one printed partial surface enclosed thereby on all sides, the surface and the partial surface being printed by intaglio printing and contrasting visually due to an ink layer of varying thickness. The invention likewise relates to the method for producing the data carrier, the printing plate used therefor, and the method for producing the printing plate.

This invention relates to a data carrier printed by intaglio printing, to the production thereof and to a printing plate suitable therefor and the method for producing said plate.

Security documents and documents of value, for example bank notes, shares, bonds, certificates, vouchers and the like, which must meet high standards with respect to forgery-proofness, are frequently printed by intaglio printing. This printing process provides a characteristic printed image that is easily recognizable to laymen and cannot be imitated with other common printing processes.

In intaglio printing, surfaces are usually rendered by a line screen, the line distance and width determining the color tone or gray value of the surface. Printed lines are usually a few tenths of a millimeter wide and separated by unprinted areas. During the printing operation, only the depressions formed in the printing plate surface by means of etching or engraving carry ink, while the actual printing plate surface is ink-free. This is obtained by wiping the printing plate surface free of excess ink after inking with a wiping cylinder or doctor blade.

During the actual printing operation the data carrier to be printed is pressed against the printing plate with high pressure by a pressure cylinder with an elastic surface. The at least partly compressible data carrier, usually made of paper, is thereby pressed into the ink-filled depressions of the printing plate and thus comes in contact with the ink. When the data carrier is detached from the printing plate, the latter pulls the ink out of the depressions. A printed image produced in this way has spaced-apart printed lines or areas that are covered with an ink layer of varying thickness in accordance with the depth of the printing plate engraving.

The high bearing pressure additionally causes the substrate material to undergo an embossing that is also noticeable on the back of the data carrier. If the engravings in the printing plate are deep enough, a data carrier printed by intaglio printing acquires through embossing and inking a printed image that forms a relief perceptible with the sense of touch. In the unprinted surface areas of the data carrier not carrying ink, the high pressures during the printing operation act like a calendering, which leads to compression and smoothing of the data carrier surface. These features make prints produced by intaglio printing distinguishable anytime from prints produced by other techniques.

The problem of the present invention is to produce more complex printed images by intaglio printing with elevated protection from forgery.

This problem is solved by the independent claims. Developments are the object of the subclaims.

The inventive data carrier is characterized by a surface printed by intaglio printing and at least one partial surface completely enclosed by said surface, the surface and partial surface being printed with the same ink but having different ink layer thickness so that they contrast visually. A sign represented by the partial surface can be any geometrical element with an e.g. circular, triangular, square or asymmetric contour structure, a pictograph, character or other symbol, preferred characters being in particular alphanumeric characters.

The printed surface and partial surface enclosed thereby on all sides are printed with an ink layer of varying thickness. Since usual intaglio inks are transparent and translucent to a certain degree, suitable layer thicknesses and an expedient choice of background color will result in color or gray tones of varying brightness and color saturation. If there is a sufficient difference of the ink layer thicknesses of adjacent surfaces, readily visible contrasts will result for the human eye without further aids. Normal lighting conditions and a normal viewing distance are assumed here.

The printed surface and partial surface enclosed thereby are in exact register if their position relative to each other is predetermined and adhered to exactly and reproducibly without the slightest deviations. If two printed images produced by successive, mutually independent printing operations are superimposed, this exactly registered positioning of the two surfaces is not possible.

In a preferred embodiment, the printed surface and partial surface are distinguishable not only visually by reason of their contrast but also with the sense of touch, i.e. tactilely. The surface relief produced by the pressure is composed of an embossing of the substrate material and the applied ink layer. The total height of the relief is based on the normal, i.e. unprinted and unembossed, data carrier surface and is at least 25 microns for feelable areas. Relief heights of more than 40 microns are especially preferred since surface elements with such relief heights are especially well perceptible tactilely.

Inventive data carriers have elevated forgery-proofness since the characteristic intaglio printed image makes them unreproducible by common printing processes. If they also have tactilely perceptible surface elements, this provides additional effective protection against imitation by color photocopying or scanning of the data carriers.

In an especially preferred embodiment, the printed surface of the data carrier additionally encloses unprinted partial areas that can in turn have the form of one or different signs of any kind. This permits a third piece of information to be rendered in negative representation, i.e. by unprinted areas in printed surroundings, in addition to the two pieces of information rendered in positive representation, i.e. with inking, in the same surface.

According to a further embodiment, the printed surface can also enclose a plurality of partial surfaces that either all have the same or different ink layer thicknesses. It is likewise possible to provide unprinted areas in the partial areas.

The form of the partial surfaces can be selected at will according to the invention, for example in the form of geometrical patterns, logos or alphanumeric characters.

The various partial surfaces, unprinted areas and the contour form of the printed surface can also be semantically related. For example, it is possible to execute the printed surface in the form of an alphanumeric character and execute the partial surfaces and any unprinted areas present in the printed surface and/or partial surfaces in the form of the same sign. If a plurality of printed surfaces are provided on the data carrier that together represent a readable piece of information, such as a multidigit number or a word, the partial areas and/or unprinted areas within a printed surface can also be executed in the form of this total information. But any other semantic relations are also possible.

The arrangement of the partial surfaces within the printed surface is as desired and subject only to the restriction that the partial surface or surfaces are largely enclosed by the printed surface. If only one partial surface exists within the printed surface, it can for example represent the same information as the printed surface and extend within the printed surface parallel to the outside contour. Preferably, a plurality of partial surfaces are disposed in the printed surface, however. The smaller the partial surfaces are, the greater the number of said partial surfaces can of course be. They can be disposed in the printed surface in any pattern. This pattern can likewise be readable information, or only a regular column and/or row arrangement. If unprinted areas are additionally provided in the printed surface, they can be disposed alternatingly with the partial surfaces.

In the inventive data carriers, unprinted areas and surfaces with varying ink layer thickness adjoin directly and in any order. This makes it possible to render very complex printed images and superimpose a plurality of pieces of information, also in positive representation, on the same surface. The freedom of design in preparing and rendering printed images produced by intaglio printing is thus enormously increased.

The inventive method for producing corresponding printed data carriers has in addition considerable economic advantages since the surfaces provided for printing with different ink layer thicknesses are produced with the same ink in one printing pass. Suitable substrate materials for printing with the inventive method are all those that can be used for intaglio printing, such as paper, plastic foils, paper laminated with plastic foils or lacquered paper, and multilayer composite materials.

The inventive intaglio printing plates are preferably produced by engraving with a fast rotating, tapered graver. In accordance with the contour form of the surface to be printed, corresponding depressions are formed in the surface of the printing plate by the engraving tool with selective variation of the engraving depth and are filled with ink for the printing operation. During printing, the ink is transferred from the depressions of the plate to the surface of a substrate. No ink is transferred from the untreated, i.e. unengraved, surface areas of the printing plate. Deep engraving of the printing plate produces a high embossed relief with a thick ink layer on the printed substrate, while flat engravings produce only a low embossed relief with a thin ink layer. If translucent inks are used, different ink layer thicknesses result in visually contrasting printed surfaces that are distinguishable even when they directly adjoin.

In order to prevent directly adjoining ink layers from flowing into each other along their borderline after being transferred to a data carrier and before the ink has dried, a so-called “separation edge” is integrated into the printing plate between surfaces with different engraving depth. Said separation edge has a tapered, wedge-shaped cross-sectional profile. The tip of the wedge is preferably located at the height of the printing plate surface or slightly thereunder.

The tip of the separation edge profile forms a largely one-dimensional line along the separation edge, similar to a knife edge. It separates the printing plate areas of varying engraving depth but produces no visible interruption of the printed ink surfaces. With the support of the separation edge integrated into the printing plate, the intaglio ink, which is of pasty consistency, is left “standing” in dimensionally stable fashion after being transferred to a substrate even when surfaces printed with varying layer thickness directly abut. In this way, extremely fine, superimposed structures with varying ink layer thickness and high edge sharpness can be printed by intaglio printing.

When engraving the printing plate, the engraving tool is guided so that a tapered separation edge is left standing between the adjoining surfaces having a different engraving depth. If a printed partial surface is completely enclosed by a likewise printed surrounding surface on the substrate, the depression or engraving of the printing plate corresponding to the partial surface must be largely enclosed by a separation edge. Ideally, the partial surface is completely enclosed by the separation edge.

If the engravings of the printing plate are not, or at least partly not, inked, that is, filled with ink, before the printing operation, the noninked area of the printing plate acts only as an embossing plate which can produce so-called blind embossings on a substrate during the intaglio printing operation. The embossed elements have similar proportions and tactile properties, with the exception of the visual impression produced by the ink, as the above-described printed surfaces and partial surfaces.

Further embodiments and advantages of the invention will be explained in the following with reference to the figures. The variants described in the examples relate primarily to very small partial surfaces. The inventively printed surface and partial surfaces can of course also be executed larger, i.e. a few millimeters to centimeters.

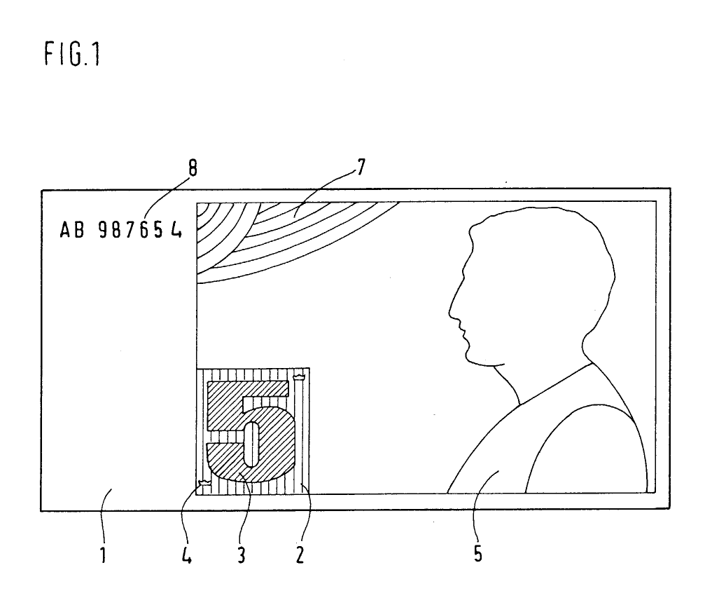

FIG. 1 shows a bank note in a front view,

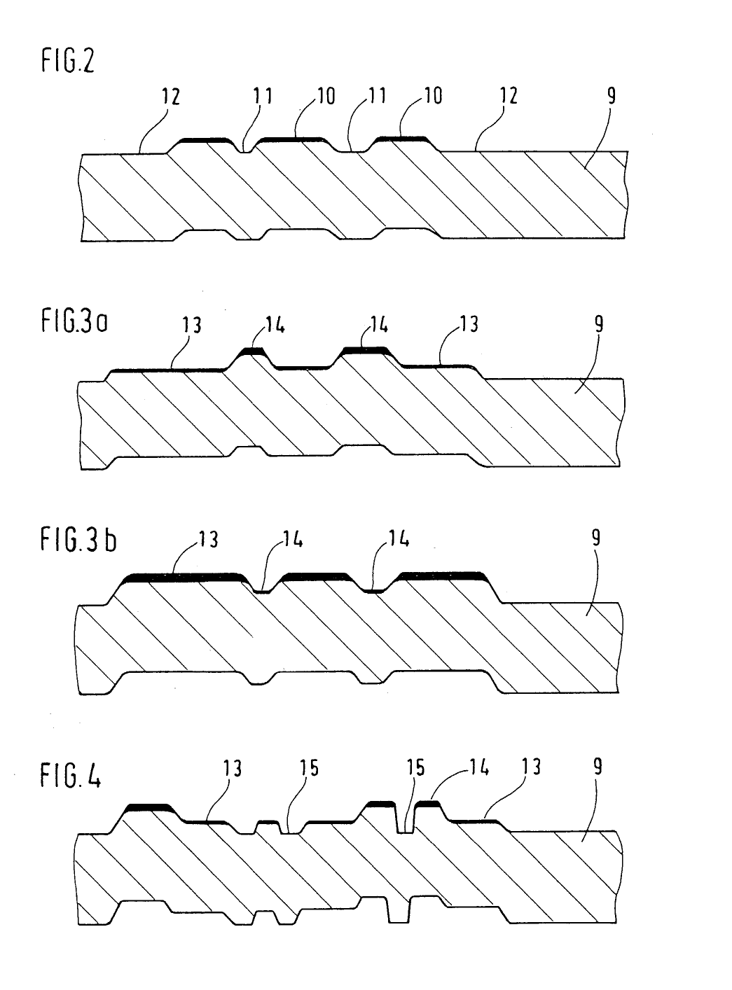

FIGS. 2, 3a, 3b and 4 show details of printed data carriers in cross section,

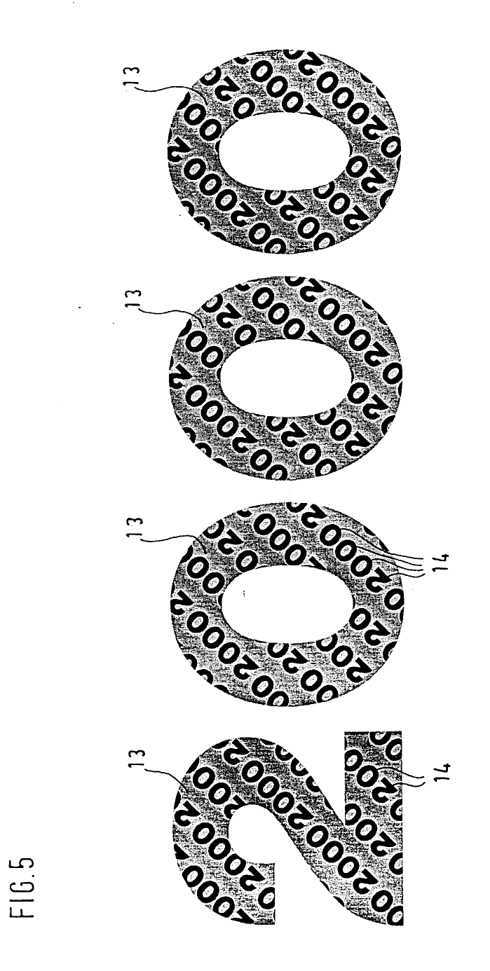

FIG. 5 shows an intaglio print in a front view with two superimposed pieces of information,

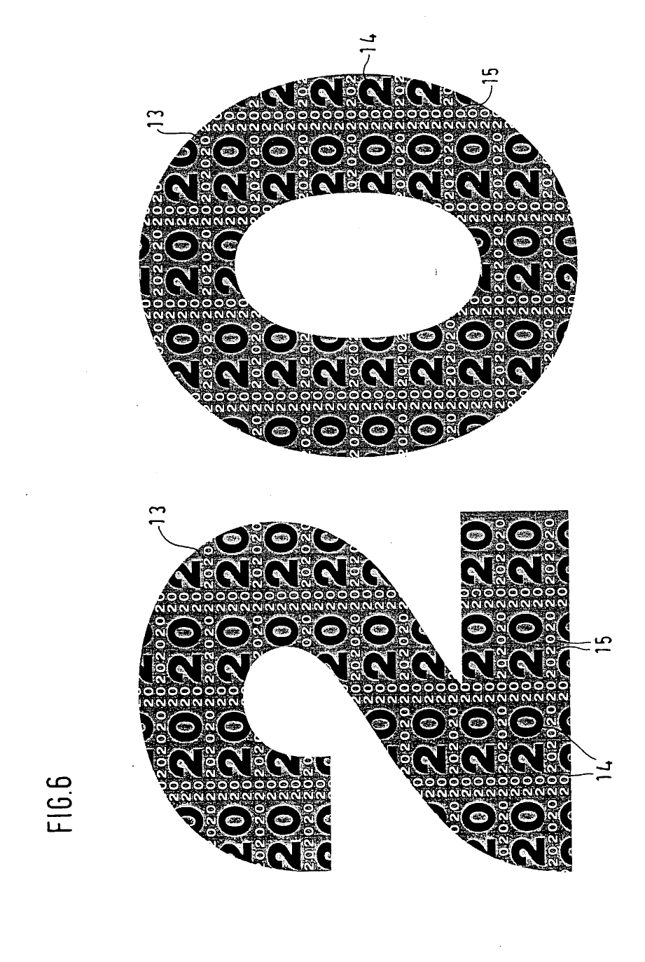

FIG. 6 shows a further intaglio print in a front view with three superimposed pieces of information,

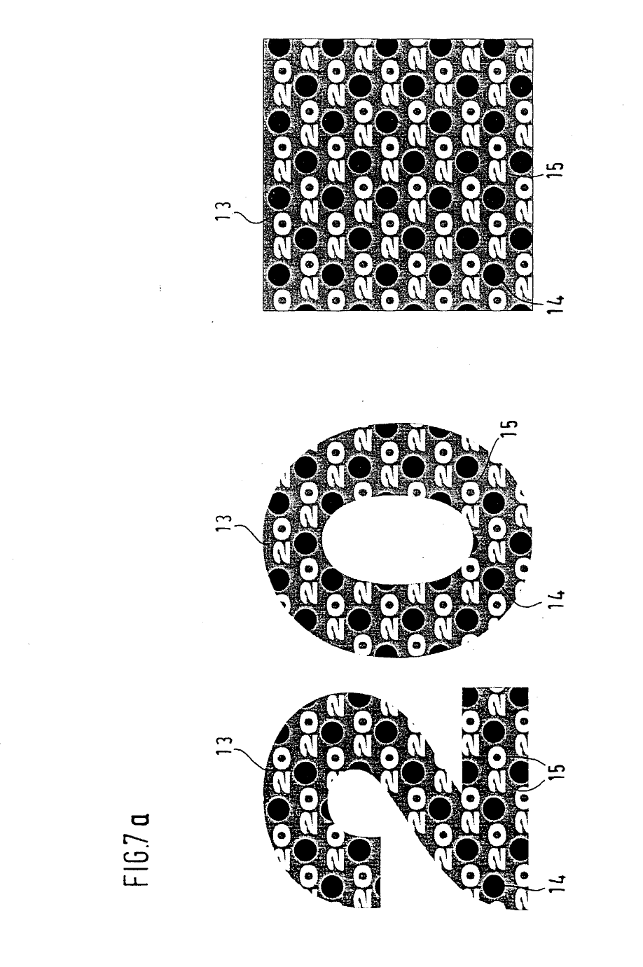

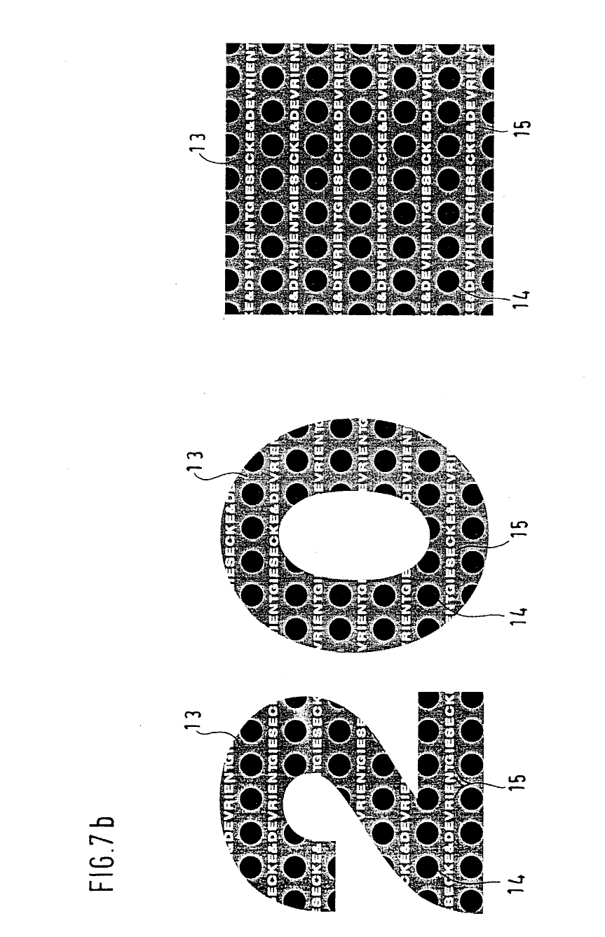

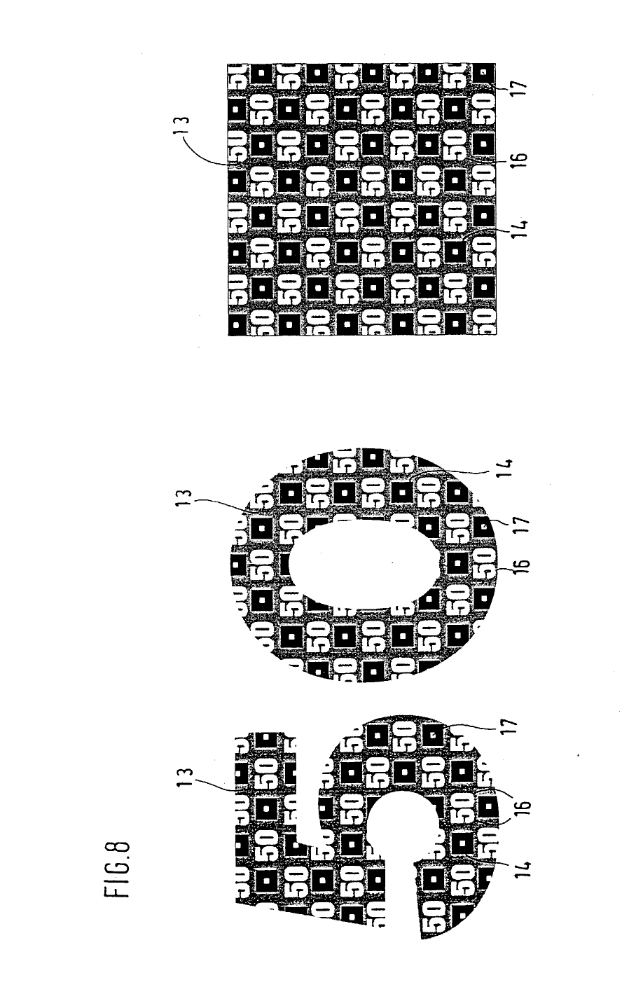

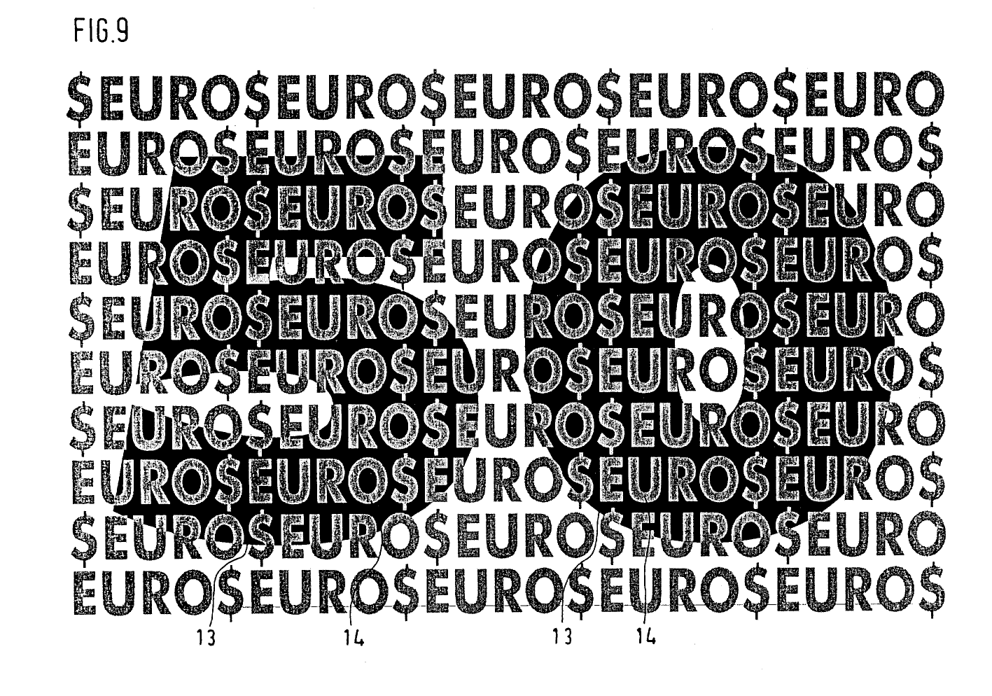

FIGS. 7a, 7b and 8 show intaglio prints in a front view with superimposed information and surfaces of varying ink layer thickness,

FIG. 9 shows a further intaglio print in a front view with superimposed information in a positive representation.

FIG. 1 sketchily shows a bank note as data carrier 1. A bank note usually has different types of prints. The illustrated bank note shows for example printed image 5 indicating a portrait. Printed image 5 is realized by conventional intaglio printing, which means that different color tones or brightnesses are rendered by line screens with varying line distance or line width. Further, background pattern 7 of fine lines produced by offset and serial number 8 applied by letterpress are present.

In the example shown here, the inventive print is provided only in a partial area of the bank note and consists of surface 2 completely printed with ink and completely enclosing partial surface 3 likewise printed with a unified ink layer. Surfaces 2 and 3 have been printed by intaglio printing with ink layers of varying thickness, which makes them visually distinguishable since there is a brightness or color contrast between surface 2 and partial surface 3. Additionally, printed surface 2 encloses unprinted partial areas 4, which can convey further information if they are designed accordingly.

In contrast, according to the prior art, information is only represented as printed surfaces against an unprinted background, i.e. in positive representation, or as an unprinted surface against a printed background. FIG. 2 shows in cross section a data carrier area printed according to the prior art, wherein substrate 9 has been printed with ink in spaced-apart surfaces 10. In positive representation, the actual information is rendered by printed surfaces 10 that stand off in high contrast from unprinted surroundings 11 and 12. In negative representation, the information is rendered by unprinted surface areas 11 while printed surfaces 10 form the surroundings and enclose information-conveying unprinted areas 11. Ink-carrying surfaces 10 are usually lines with a width of clearly less than one millimeter in conventional intaglio printing.

FIGS. 3a and 3b illustrate the inventive principle of rendering information in a continuously printed surface by selective variation of ink layer thickness between two layer thickness levels. FIGS. 3a and 3b show in cross section a data carrier area printed according to the invention. In partial surfaces 14 completely enclosed by surrounding print area 13 (which is not recognizable in cross section), the ink layer thickness varies so clearly that a visually well perceptible color or brightness contrast arises between surfaces 13 and 14. In FIG. 3a, partial surfaces 14 have a greater ink layer thickness in comparison to their surroundings, while FIG. 3b shows the reverse case, i.e. surrounding surface 13 is printed with a thicker ink layer than partial surfaces 14. If transparent ink is used for producing surfaces 13 and 14, the surfaces with the smaller ink layer thickness appear in a lighter color tone. In this case, partial surfaces 14 shown in FIG. 3a stand out as darker surfaces against a lighter background, while partial surfaces 14 shown in FIG. 3b appear in a lighter color tone than surrounding printed surface 13.

Information can thus be represented by printed, i.e. ink-carrying, partial surfaces 14 against likewise ink-carrying surroundings 13. If the shape and contour of printed surface 13 likewise conveys information, two superimposed pieces of information can be rendered in positive representation on the same surface.

FIG. 4 likewise shows in cross section a detail of an inventive data carrier. Here, the printed surface additionally has unprinted partial areas 15 integrated therein that are completely enclosed by printed surfaces 13 and 14 (which is again not recognizable in cross section). If unprinted areas 15 are designed accordingly, these areas can render further, additional information in negative representation.

The following FIGS. 5 to 9 show enlarged representations of different, preferred embodiments of the invention in a front view. For reasons of clarity, only the printed image produced by intaglio printing according to the invention is shown. The ratios of size of the surfaces to the partial surfaces are rendered realistically.

In FIG. 5 the number “2000” is rendered, each individual digit being represented by inventively printed surface 13 having a unified ink layer of a certain layer thickness. Each printed surface 13 representing a digit contains partial surfaces 14 enclosed thereby on all sides that have been printed with a thicker ink layer and therefore appear darker. The contour form of partial surfaces 14 is selected in this example so that each partial surface 14 likewise represents a digit. In FIG. 5, the digit sequence of partial surfaces 14 renders the same number as rendered by the sequence of individual print areas 13. Any other signs, patterns or symbols can of course also be used. If surfaces 13 are printed with a printing plate having for example an engraving depth of e.g. 15 microns in the corresponding areas, while the partial areas of the printing plate corresponding to partial surfaces 14 are produced for example with an engraving depth of e.g. 100 microns, not only a visually well perceptible contrast arises between surfaces 13 and 14 of the data carrier but also a feelable level difference. This is because partial surfaces 14 printed by deep engravings produce on the data carrier a raised relief that can be clearly perceived by feeling with the fingertips.

In FIG. 6, the contour form of printed surfaces 13 renders the number “20.” Each of the two surfaces 13 represents a digit and contains partial surfaces 14 that are printed with greater ink layer thickness and therefore perceived darker. The form of partial surfaces 14 likewise renders the number “20.” Additionally, surfaces 13 printed with the thin ink layer enclose unprinted partial surfaces 15 that are so designed as to likewise render the number “20.” Thus, three pieces of information with matching content in the present example are rendered on the same surface. Two pieces of information are rendered in positive representation while the third piece of information is rendered in negative representation. Unprinted areas 15 are disposed like a net within printed surface 13 and frame each partial surface 14.

In preferred embodiments according to the representations in FIGS. 5 and 6, the signs rendered by printed surfaces 13 have a height or size of about one centimeter. Signs of this size are still easy to read at a great viewing distance. Enclosed partial surfaces 14 preferably render signs with a size of about one millimeter. Signs of this size are still easy to read with the naked eye at a normal viewing distance of about 20 to 50 centimeters. If additional signs are integrated by unprinted partial surfaces, they are preferably executed as microwriting. The preferred sign size is only a few tenths of a millimeter. Such microcharacters are only readable without effort with the aid of magnifying means, for example a magnifying glass, and constitute an additional security feature because such fine structures are not resolved with sufficient precision by customary photocopiers and scanners.

FIGS. 7a and 7b show two inventive printed images in which printed surfaces 13 render both characters (the digits “2” and “0”) and a geometrical element (a square). Printed partial surfaces 14 of this example constitute a surface relief formed especially strongly by embossing and applied ink layer and are therefore perceptible also tactilely. The information represented by partial surfaces 14 corresponds to a simple geometrical element in the form of a circle here.

Suitable elements that are especially well perceptible tactilely are in particular structures with a geometrically simple contour. The size of the feelable elements is preferably a few millimeters and they preferably have a distance apart of at least about 0.5 millimeters. Unprinted partial surfaces 15 integrated into the printed surface render the number “20” in FIG. 7a. A further preferred variant not shown in the figure is to render solely the same digit “2” by unprinted partial surfaces 15 in the digit “2” represented by printed surface 13, and accordingly form unprinted partial surfaces 15 like-wise as the digit “0” in the digit “0” rendered by surface 13.

In FIG. 7b, unprinted areas 15 have the shape of characters that follow each other in a line and form microwriting. Their information content differs from the information content rendered by printed surfaces 13 and partial surfaces 14. A line of microwriting rendered in negative representation is followed by a line of circles rendered by partial surfaces 14 with a thick ink layer. In FIG. 7a, however, the signs rendered by unprinted areas 15 and printed partial surfaces 14 are so disposed as to follow each other alternatingly in both the vertical and the horizontal directions.

In FIG. 8, the unprinted areas are so disposed in the printed surface that there is both first unprinted areas 16 enclosed by a printed surface with small ink layer thickness, in this case by printed surface 13, and second unprinted areas 17 enclosed by an ink surface with great ink layer thickness, partial surfaces 14 here. In FIG. 8, first unprinted partial surfaces 16 render the digits “5” and “0.” Second unprinted partial surfaces 17 as well as printed, dark partial surfaces 14 are executed as squares.

In FIG. 9, printed, dark surfaces 13 render the digits of the number “50,” the visual dark impression being conveyed by a thick ink layer. Partial surfaces 14 enclosed by printed surface 13 have the form of letters together rendering the repeated word “EURO” followed by a “$” sign in each case. They are lighter since they are produced by an ink layer with small thickness. The information formed by partial surfaces 14 within printed surface 13 also extends into the surroundings of printed surface 13. In the shown example, the signs formed within printed surface 13 by printed partial surfaces 14 also extend into the unprinted surroundings of surface 13. This variant can also be used in the other embodiments.

1. A data carrier, in particular bank note, paper of value or the like, having at least one printed surface (13) and at least one partial surface (14) largely enclosed by said surface, wherein the surface (13) and the partial surface (14) are printed by intaglio printing, the two surfaces having different ink layer thicknesses and being distinguishable from each other.

2. A data carrier according to claim 1, characterized in that the partial surface (14) is enclosed completely.

3. A data carrier according to claim 1 or 2, characterized in that the printed surface (13) and the partial surface (14) are distinguishable visually.

4. A data carrier according to at least one of claims 1 to 3, characterized in that the printed surface (13) and partial surface (14) are in exact register.

5. A data carrier according to at least one of claims 1 to 4, characterized in that the surface (13) has a smaller ink layer thickness than the partial surface (14) and is executed so that the background shines through.

6. A data carrier according to at least one of claims 1 to 4, characterized in that the partial surface (14) has a smaller ink layer thickness than the surface (13) and is executed so that the background shows through.

7. A data carrier according to at least one of claims 1 to 6, characterized in that the printed surface (13) and/or the printed partial surface (14) additionally have at least one unprinted area (15, 16, 17) completely enclosed by the printed surface (13) or the printed partial surface (14).

8. A data carrier according to at least one of claims 1 to 7, characterized in that the printed partial surface (14) and/or the unprinted area (15, 16, 17) has the form of a character, in particular an alphanumeric character.

9. A data carrier according to at least one of claims 1 to 8, characterized in that the printed partial surface (14) and/or the unprinted area (15, 16, 17) has the form of a geometrical element, a pictograph or a symbol.

10. A data carrier according to claim 8 or 9, characterized in that a plurality of partial surfaces (14) and/or unprinted areas (15, 16, 17) are provided in the surface (13).

11. A data carrier according to claim 10, characterized in that the partial surfaces (14) and/or unprinted areas (15, 16, 17) are executed differently and the information rendered thereby is semantically related.

12. A data carrier according to at least one of claims 1 to 11, characterized in that the contour form of the printed surface (13) renders information.

13. A data carrier according to claim 12, characterized in that the partial surfaces (14) and/or the unprinted areas (15, 16, 17) render the same information as the contour form of the printed surface (13).

14. A data carrier according to at least one of claims 1 to 13, characterized in that the surface (13) or the partial surface (14) is tactile.

15. A data carrier according to claim 14, characterized in that the tactile surface (13) or partial surface (14) has a height of at least 25 microns, in particular 40 microns, relative to the data carrier surface.

16. A data carrier according to at least one of claims 10 to 15, characterized in that at least two partial surfaces (14) have different ink layer thicknesses.

17. A data carrier according to at least one of claims 1 to 16, characterized in that a plurality of surfaces (13) are provided that preferably have different contour forms.

18. A data carrier according to any of claims 1 to 17, characterized in that printed surfaces corresponding to the partial surfaces (14) are repeated outside the surface (13) so that the information rendered by the partial surfaces (14) also extends into the surroundings of the surface (13).

19. A method for producing a printed data carrier, in particular bank note, paper of value or the like, wherein a substrate is printed by intaglio printing, ink is applied in varying ink layer thickness in one printing operation to a surface and at least one partial surface enclosed thereby so that surface and partial surface are distinguishable visually from each other.

20. An intaglio printing plate with depressions provided for receiving ink in the surface thereof, characterized in that the surface (13) taken up by a depression completely encloses at least one partial surface (14), and the partial surface (14) has an engraving depth that differs from the engraving depth of the surface (13), and the partial surface (14) is at least partly enclosed by a tapered separation edge.

21. A method for producing an intaglio printing plate wherein depressions provided for receiving ink and forming a surface are engraved into the surface of the plate, characterized in that at least one partial surface completely enclosed by said surface is produced, and the engraving of the partial surface is effected with a different engraving depth from that of the enclosing surface, and the material of the printing plate is removed by the engraving such that a tapered separation edge at least partly enclosing the partial surface is left standing in the depression.
